(19) United States
(12) Patent Application Publication
(10) Pub. No.: US 2026/0340473 A1
(43) Pub. Date: Oct. 29, 2026

(54) UTILIZING A GENERALIZED PAULI-LINDBLAD MODEL FOR SIMULATING PAULI CHANNELS AND PERFORMING QUANTUM ERROR MITIGATION

(71) Applicant: International Business Machines Corporation, Armonk, NY (US)

(72) Inventors: Alireza Seif Tabrizi, Adelphi, MD (US); Moein Malek, Elmsford, NY (US); Swarnadeep Majumder, Durham, NC (US); Luke Colin Gene Govia, Sunnyvale, CA (US); Paul Kristan Temme, Ossining, NY (US)

(21) Appl. No.: 19/191,306

(22) Filed: Apr. 28, 2025

(51) Int. Cl. G06N 10/70

(52) U.S. Cl. CPC G06N 10/70

(57) ABSTRACT

A method, system, and computer program product for quantum error mitigation. A quantum circuit is constructed and measured for Pauli fidelities. Pauli fidelities refer to a set of parameters used to characterize the performance of a quantum system or device. The measured fidelities are then fitted to the generalized Pauli-Lindblad model with negative or complex rates (i.e., having parameters with negative or complex numbers), which enables the generalized Pauli-Lindblad model to capture all the Pauli channels. A set of mitigation circuits is then generated by sampling from an inverse of the generalized Pauli-Lindblad model. The mitigation circuits are then used to perform quantum error mitigation on the quantum circuit. In this manner, quantum error mitigation is improved by reducing errors by utilizing a generalized Pauli-Lindblad model that captures all the Pauli channels as opposed to a subclass of the Pauli channels.

### TECHNICAL FIELD

The present disclosure relates generally to quantum error mitigation, and more particularly to utilizing a generalized Pauli-Lindblad model, whose parameters may be complex numbers, for simulating Pauli channels and performing quantum error mitigation.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

Current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation techniques have been developed. Quantum error mitigation refers to mitigating computation errors while keeping the hardware load to a minimum. That is, quantum error mitigation is a technique that reduces the effects of noise and error on measured observables.

Quantum error mitigation techniques, such as probabilistic error cancellation and probabilistic error amplification, benefit from accurate noise models. The Pauli-Lindblad noise model is one of the most successful models for those applications. In existing implementations, the model decomposes into a series of simple Pauli channels with one- and two-local terms that follow the qubit topology.

Currently, noise learning protocols for quantum error mitigation procedures use a learning and migration scheme that only works if the noise has positive generators (evolution of a quantum system's state). As a result, the constraints for the parameters of the Pauli-Lindblad model are limited to only positive values resulting in the capture of only a subclass of Pauli channels. A Pauli channel is a quantum channel that probabilistically applies a Pauli operator (set of operators, denoted as X, Y, and Z, that correspond to the spin along the x, y, and z axes, respectively) to the input state. Unfortunately, by only capturing a subclass of Pauli channels, systematic errors result during quantum error mitigation.

### SUMMARY

In one embodiment of the present disclosure, a method for quantum error mitigation comprises constructing a quantum circuit and measuring Pauli fidelities of the quantum circuit. The method further comprises fitting the Pauli fidelities to a generalized Pauli-Lindblad model with negative or complex rates. The method additionally comprises generating mitigation circuits by sampling from an inverse of the generalized Pauli-Lindblad model. Furthermore, the method comprises a performing quantum error mitigation on the quantum circuit using the mitigation circuits.

Furthermore, in one embodiment of the present disclosure, the method additionally comprises allowing a vector of parameters used in the generalized Pauli-Lindblad model to include complex numbers thereby expanding a scope of the generalized Pauli-Lindblad model to describe all Pauli channels.

Additionally, in one embodiment of the present disclosure, the method further comprises measuring a Pauli channel to estimate probabilities of Pauli errors affecting a quantum system. The method additionally comprises learning the vector of parameters of the generalized Pauli-Lindblad model based on the measured Pauli channel.

Furthermore, in one embodiment of the present disclosure, the method additionally comprises sampling the parameters of the generalized Pauli-Lindblad model in a sequential manner to implement the Pauli channel as a full Pauli channel.

Additionally, in one embodiment of the present disclosure, the method further comprises simulating a full Pauli channel based on sampling the generalized Pauli-Lindblad model.

Furthermore, in one embodiment of the present disclosure, the quantum error mitigation comprises probabilistic error amplification.

Additionally, in one embodiment of the present disclosure, the quantum error mitigation comprises probabilistic error cancellation.

Other forms of the embodiments of the method described above are in a system and in a computer program product.

Accordingly, embodiments of the present disclosure improve the accuracy of quantum error mitigation by reducing errors by utilizing a generalized Pauli-Lindblad model that captures all the Pauli channels as opposed to a subclass of the Pauli channels.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for improving quantum error mitigation by using a generalized Pauli-Lindblad model in accordance with an embodiment of the present disclosure.

FIG. 3 illustrates an embodiment of the present disclosure of the hardware configuration of the classical computer which is representative of a hardware environment for practicing the present disclosure;

FIG. 4 is a flowchart of a method for utilizing a generalized Pauli-Lindblad model for improving quantum error mitigation in accordance with an embodiment of the present disclosure;

FIG. 5 is a flowchart of a method for learning the generalized Pauli-Lindblad model in accordance with an embodiment of the present disclosure; and

FIG. 6 is a flowchart of a method for simulating a full Pauli channel using the generalized Pauli-Lindblad model in accordance with an embodiment of the present disclosure.

### DETAILED DESCRIPTION

In one embodiment of the present disclosure, a method for quantum error mitigation comprises constructing a quantum circuit and measuring Pauli fidelities of the quantum circuit. The method further comprises fitting the Pauli fidelities to a generalized Pauli-Lindblad model with negative or complex rates. The method additionally comprises generating mitigation circuits by sampling from an inverse of the generalized Pauli-Lindblad model. Furthermore, the method comprises a performing quantum error mitigation on the quantum circuit using the mitigation circuits.

In this manner, the accuracy of quantum error mitigation is improved by reducing errors by utilizing a generalized Pauli-Lindblad model that captures all the Pauli channels as opposed to a subclass of the Pauli channels.

Furthermore, in one embodiment of the present disclosure, the method additionally comprises allowing a vector of parameters used in the generalized Pauli-Lindblad model to include complex numbers thereby expanding a scope of the generalized Pauli-Lindblad model to describe all Pauli channels.

In this manner, the Pauli-Lindblad model is able to capture all Pauli channels as opposed to a subclass of the Pauli channels.

Additionally, in one embodiment of the present disclosure, the method further comprises measuring a Pauli channel to estimate probabilities of Pauli errors affecting a quantum system. The method additionally comprises learning the vector of parameters of the generalized Pauli-Lindblad model based on the measured Pauli channel.

In this manner, the Pauli-Lindblad model is able to capture all Pauli channels as opposed to a subclass of the Pauli channels.

Furthermore, in one embodiment of the present disclosure, the method additionally comprises sampling the parameters of the generalized Pauli-Lindblad model in a sequential manner to implement the Pauli channel as a full Pauli channel.

In this manner, a complete and fully defined Pauli channel that encompasses all possible single-qubit Pauli errors can be implemented.

Additionally, in one embodiment of the present disclosure, the method further comprises simulating a full Pauli channel based on sampling the generalized Pauli-Lindblad model.

In this manner, the generalized Pauli-Lindblad model can be applied to simulating Pauli channels.

Furthermore, in one embodiment of the present disclosure, the quantum error mitigation comprises probabilistic error amplification.

In this manner, the generalized Pauli-Lindblad model can be applied to probabilistic error amplification.

Additionally, in one embodiment of the present disclosure, the quantum error mitigation comprises probabilistic error cancellation.

In this manner, the generalized Pauli-Lindblad model can be applied to probabilistic error cancellation.

Other forms of the embodiments of the method described above are in a system and in a computer program product.

As stated above, current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation techniques have been developed. Quantum error mitigation refers to mitigating computation errors while keeping the hardware load to a minimum. That is, quantum error mitigation is a technique that reduces the effects of noise and error on measured observables.

Quantum error mitigation techniques, such as probabilistic error cancellation and probabilistic error amplification, benefit from accurate noise models. The Pauli-Lindblad noise model is one of the most successful models for those applications. In existing implementations, the model decomposes into a series of simple Pauli channels with one- and two-local terms that follow the qubit topology.

Currently, noise learning protocols for quantum error mitigation procedures use a learning and migration scheme that only works if the noise has positive generators (evolution of a quantum system's state). As a result, the constraints for the parameters of the Pauli-Lindblad model are limited to only positive values resulting in the capture of only a subclass of Pauli channels. A Pauli channel is a quantum channel that probabilistically applies a Pauli operator (set of operators, denoted as X, Y, and Z, that correspond to the spin along the x, y, and z axes, respectively) to the input state. Unfortunately, by only capturing a subclass of Pauli channels, systematic errors result during quantum error mitigation.

The embodiments of the present disclosure provide the means for reducing errors during quantum mitigation by utilizing a generalized Pauli-Lindblad model that captures all the Pauli channels as opposed to a subclass of the Pauli channels. A Pauli channel, as used herein, refers to a quantum channel that probabilistically applies a Pauli operator to the input state. A Pauli operator, as used herein, refers to a set of operators, denoted as X, Y, and Z, that correspond to the spin along the x, y, and z axes, respectively. In one embodiment, the generalized Pauli-Lindblad model is learned by allowing the constraints of the parameters of the Pauli-Lindblad model to include complex numbers thereby expanding a scope of the Pauli-Lindblad model to describe all Pauli channels. A Pauli-Lindblad model (also referred to as the “Pauli-Lindblad noise model”), as used herein, refers to a model that decomposes into a series of Pauli channels with one- and two-local terms that follow the qubit topology. A generalized Pauli-Lindblad model, as used herein, refers to a Pauli-Lindblad model where the constraints of the parameters of the Pauli-Lindblad model have been relaxed to include complex numbers. In one embodiment, in the generalized Pauli-Lindblad model, the Lindblad rate λₖ can be a complex number. As a result, the corresponding weight wₖ can also be a complex number. The parameters, such as a vector of parameters, of the generalized Pauli-Lindblad model are learned based on measuring a Pauli channel to estimate the probabilities of the Pauli errors affecting the quantum system. After learning the parameters (Pauli error rates) that characterize the generalized Pauli-Lindblad model (i.e., learning the generalized Pauli-Lindblad model), the generalized Pauli-Lindblad model may be utilized to simulate the full Pauli channel based on sampling the generalized Pauli-Lindblad model. A full Pauli channel, as used herein, refers to the complete and fully defined Pauli channel that encompasses all possible single-qubit Pauli errors. Furthermore, in an alternative embodiment, the generalized Pauli-Lindblad model may be utilized to perform quantum error mitigation (e.g., probabilistic error amplification, probabilistic error cancellation). For example, Pauli fidelities are measured from a constructed quantum circuit. Pauli fidelities, as used herein, refer to a set of parameters used to characterize the performance of a quantum system or device. A Pauli fidelity, as used herein, quantifies how well a noise quantum channel (e.g., gate, process) preserves the expectation value of a particular Pauli operator. The measured fidelities are then fitted to the generalized Pauli-Lindblad model with negative or complex rates (i.e., having parameters with negative or complex numbers). That is, the rates describing how the quantum system evolves due to noise are allowed to be negative or complex numbers rather than only real and positive numbers as in currently used Pauli-Lindblad models. A set of mitigation circuits is then generated by sampling from an inverse of the generalized Pauli-Lindblad model. A mitigation circuit, as used herein, refers to a quantum circuit designed to reduce the effects of noise errors or noise during quantum computations. The mitigation circuits are then used to perform quantum error mitigation on the quantum circuit. In this manner, quantum error mitigation is improved by reducing errors by utilizing a generalized Pauli-Lindblad model that captures all the Pauli channels as opposed to a subclass of the Pauli channels. These and other features will be discussed in further detail below.

In some embodiments of the present disclosure, the present disclosure comprises a method, system, and computer program product for quantum error mitigation. In one embodiment of the present disclosure, a quantum circuit is constructed and measured for Pauli fidelities. Pauli fidelities, as used herein, refer to a set of parameters used to characterize the performance of a quantum system or device. A Pauli fidelity, as used herein, quantifies how well a noise quantum channel (e.g., gate, process) preserves the expectation value of a particular Pauli operator. The measured fidelities are then fitted to the generalized Pauli-Lindblad model with negative or complex rates (i.e., having parameters with negative or complex numbers), which enables the generalized Pauli-Lindblad model to capture all the Pauli channels. That is, the rates describing how the quantum system evolves due to noise are allowed to be negative or complex numbers rather than only real and positive numbers as in currently used Pauli-Lindblad models. In one embodiment, in the generalized Pauli-Lindblad model, the Lindblad rate λₖ can be a complex number. As a result, the corresponding weight wₖ can also be a complex number. A set of mitigation circuits is then generated by sampling from an inverse of the generalized Pauli-Lindblad model. A mitigation circuit, as used herein, refers to a quantum circuit designed to reduce the effects of noise errors or noise during quantum computations. The mitigation circuits are then used to perform quantum error mitigation on the quantum circuit. In this manner, quantum error mitigation is improved by reducing errors by utilizing a generalized Pauli-Lindblad model that captures all the Pauli channels as opposed to a subclass of the Pauli channels.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

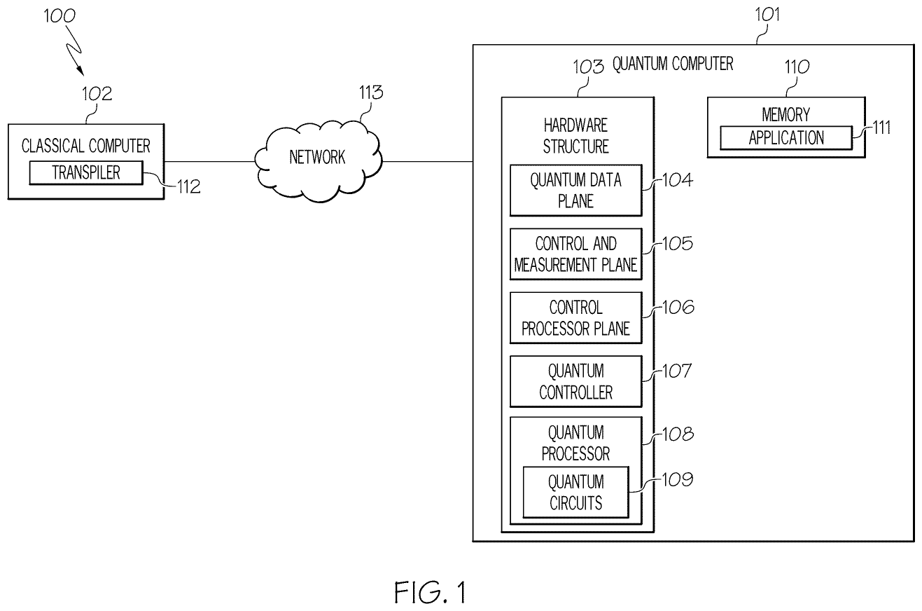

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to utilize a generalized Pauli-Lindblad model for improving quantum error mitigation.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{jθX/2}, which corresponds to a rotation of the qubit state around the X-axis by the given angle theta θ on the Bloch sphere), RY (also identified as Ry) (performs e^{jθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

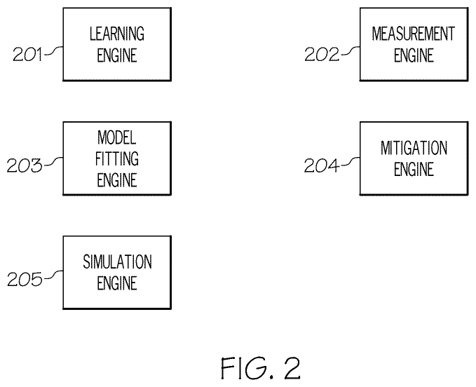

In one embodiment, memory 110 stores an application 111 that may be configured to implement one or more of the methods described herein in accordance with one or more embodiments. For example, application 111 may implement a program for utilizing a generalized Pauli-Lindblad model for improving quantum error mitigation as discussed further below in connection with FIGS. 2 and 4-6. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

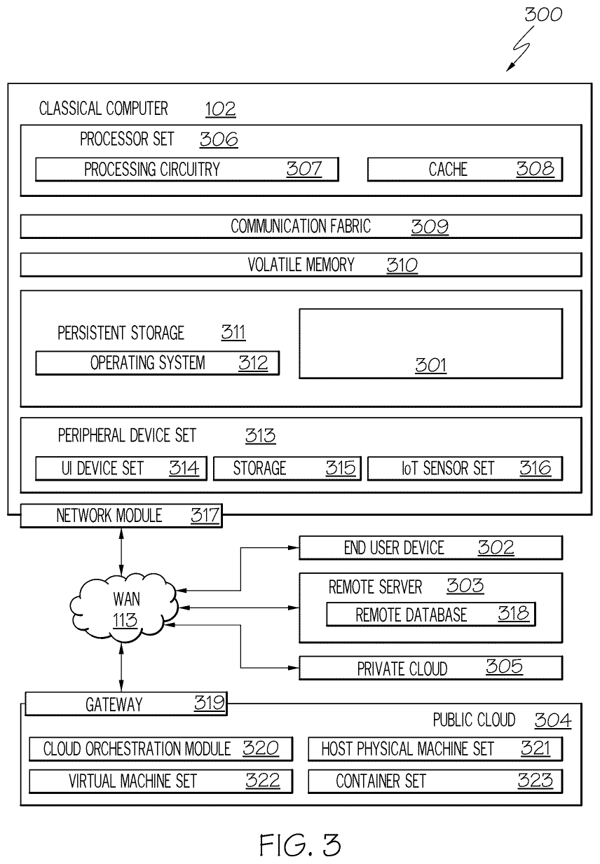

Furthermore, classical computer 102 is configured to use a generalized Pauli-Lindblad model for improving quantum error mitigation as discussed further below in connection with FIGS. 2 and 4-6. A description of the software components of classical computer 102 is provided below in connection with FIG. 2 and a description of the hardware configuration of classical computer 102 is provided further below in connection with FIG. 3.

System 100 is not to be limited in scope to any one particular network architecture. System 100 may include any number of quantum computers 101, classical computers 102, and networks 113.

A discussion regarding the software components used by classical computer 102 for improving quantum error mitigation by using a generalized Pauli-Lindblad model is provided below in connection with FIG. 2.

FIG. 2 is a diagram of the software components of classical computer 102 (FIG. 1) for improving quantum error mitigation by using a generalized Pauli-Lindblad model in accordance with an embodiment of the present disclosure.

Referring to FIG. 2, in conjunction with FIG. 1, classical computer 102 includes a learning engine 201 configured to learn a generalized Pauli-Lindblad model.

A Pauli-Lindblad model (also referred to as the “Pauli-Lindblad noise model”), as used herein, refers to a model that decomposes into a series of Pauli channels with one- and two-local terms that follow the qubit topology. A generalized Pauli-Lindblad model, as used herein, refers to a Pauli-Lindblad model where the constraints of the parameters of the Pauli-Lindblad model have been relaxed to include complex numbers. The parameters, such as a vector of parameters, of the generalized Pauli-Lindblad model are learned based on measuring a Pauli channel to estimate the probabilities of the Pauli errors affecting the quantum system.

In one embodiment, learning engine 201 learns the generalized Pauli-Lindblad model by allowing the constraints of the parameters, such as a vector of parameters (A), of the Pauli-Lindblad model to be relaxed so that the parameters include complex numbers thereby expanding a scope of the Pauli-Lindblad model to describe all Pauli channels.

Furthermore, in one embodiment, learning engine 201 measures a Pauli channel to estimate the probabilities of the Pauli errors affecting the quantum system (e.g., quantum computer 101). A Pauli channel, as used herein, refers to a quantum channel that probabilistically applies a Pauli operator to the input state. It is a fundamental model for noise in quantum systems and is used to analyze error correction and fault tolerance. A Pauli operator, as used herein, refers to a set of operators, denoted as X, Y, and Z, that correspond to the spin along the x, y, and z axes, respectively.

In one embodiment, learning engine 201 learns the vector of parameters (\vec{λ}) of the generalized Pauli-Lindblad model based on the measured Pauli channel as discussed further below.

In one embodiment, the measured Pauli channel is represented by ε(ρ)=ΣₖpₖPₖρPₖ. In one embodiment, the generator (generates the evolution of the quantum state) is [symbol] (ρ)=Σₖλₖ(PₖρPₖ−ρ) such that [symbol] =ε.

In the context of quantum computing and the Lindblad master equation, the generator ( [symbol] (ρ)) is the evolution of a quantum system's state (represented by the density matrix ρ) which is governed by an operator, L(ρ), which describes the system's dynamics. The Lindblad master equation describes the time evolution of an open quantum system (a system that interacts with its environment). The density matrix (ρ), as used herein, represents the statistical properties of a quantum system, including its coherence and purity. The operator, L(ρ), when applied to the density matrix, determines how the quantum system evolves over time due to interactions with its environment. The Lindbladian generator or L generates evolution through ρ(t)≈ρ(0)+dtLρ(0). In this sense, the generator describes how the system changes its state over time as a result of interactions with the environment.

Furthermore, in one embodiment, learning engine 201 finds the vector of parameters (\vec{λ}) using the following formula:

$$\vec{λ} = \frac{1}{{d}^{2}} H log ( H \vec{p} ) ,$$

where H is the Walsh-Hadamard transform (hᵢⱼ=1 if [Pᵢ, Pⱼ]=0 and −1 otherwise), d is the dimension, and \vec{p} is the vector of error probabilities.

In one embodiment, for models with locality constraints,

$$\vec{λ} = min ( {‖ A \vec{λ} - \vec{y} ‖}_{2}^{2} ) ,$$

where \vec{y} is the vector of the logarithm of measured local fidelities, and A is a matrix showing how \vec{λ} linearly depends on \vec{y}. A solution is given by \vec{λ}=A⁻¹ \vec{y}.

Hence, the vector \vec{λ} is based on the logarithm of measured local fidelities under the constraint of locality. That is, the model's behavior needs to be consistent with the local properties it is trying to model. In one embodiment, the vector \vec{λ} is computed by finding the minimal difference between a transformed model λ, (A\vec{λ}), and measured local log-fidelities (\vec{y}), where A is a matrix representing this relationship.

In one embodiment, the equation

$$( \vec{λ} = min ( {‖ A \vec{λ} - \vec{y} ‖}_{2}^{2} )$$

is a minimization problem. The goal is to find the best λ that minimizes the difference between a transformed model λ (represented by (A\vec{λ})) and the vector of logarithms of measured local log-fidelities (\vec{y}). In one embodiment, \vec{y} represents the vector of logarithms of measured local fidelities, where “local fidelities” refer to a measure of how accurately a model predicts in a specific locality. A represents a matrix that defines how \vec{λ} changes with \vec{y}. That is, A is a map that represents how the “unconstrained model parameters” \vec{λ} transform to incorporate the locality constraints from the measured local fidelities, \vec{y}.

Furthermore, as previously discussed, the solution is given by \vec{λ}=A⁻¹\vec{y}, which indicates that if the matrix A is invertible, then a solution for \vec{λ} can be obtained by applying the inverse of A to the vector \vec{y}.

In one embodiment, learning engine 201 does not impose the requirement that the values of the vector of parameters (\vec{λ}) are positive. Such values may be negative or complex numbers. As a result, the Pauli-Lindblad model is generalized (i.e., the generalized Pauli-Lindblad model) such that it is able to capture all Pauli channels.

In one embodiment, all the terms in the generalized Pauli-Lindblad model commute. That is, ε(ρ)=Πₖε(ρ)=Πₖ [symbol] (ρ) where [symbol] ₖ(ρ)=λₖ(PₖρPₖ−ρ). In other words, changing the order of the terms used in the operation does not change the final result.

As a result, each term (parameter) in the generalized Pauli-Lindblad model, which represents a particular type or strength of noise, may be implemented individually. In one embodiment, learning engine 201 performs sequential implementation of the terms in the generalized Pauli-Lindblad model, which results in sampling from the full model. That is, by processing the parameters of the generalized Pauli-Lindblad model in a sequential manner rather than in a single, all-at-once operation, the sampling process mirrors sampling from the complete, fully defined Pauli-Lindblad model.

In one embodiment, learning engine 201 performs sequential implementation by implementing the terms of the generalized Pauli-Lindblad model in sequence (one after another) as opposed to implementing all the terms at once.

In one embodiment, when implementing the terms of the generalized Pauli-Lindblad model sequentially, each term will result in a quantum state evolution. Such repeated implementation, or sampling, of the terms of the generalized Pauli-Lindblad model effectively simulates the full model's dynamics to understand the complex noise model.

In one embodiment, a Pauli channel can be simulated by sequentially implementing terms of the generalized Pauli-Lindblad model and sampling from them. By sequentially implementing the term results, such as implementing each error type or term one after another, the overall effect of the Pauli channel can be simulated.

In one embodiment, instead of directly calculating the outcome of each error, a sampling approach may be utilized, drawing random samples from the generalized Pauli-Lindblad model for each term to represent the errors probabilistically.

In one embodiment, by sequentially implementing these sampled terms, the entire Pauli channel can be simulated allowing for a more accurate understanding of the overall error behavior in the quantum system. That is, by sequentially applying the terms (representing source of noise or errors) via sampling, the combined effect of the entire model, including the full Pauli channel, can effectively be simulated. That is, all possible noise channel effects, such as Pauli rotations, can be implemented via such sampling.

In one embodiment, [symbol] (ρ)=λₖ(PₖρPₖ−ρ). As a result, the generated channel is

$${ℰ}_{k} ( ρ ) = {w}_{k} ρ + ( 1 - {w}_{k} ) {P}_{k} ρ {P}_{k} , where {w}_{k} = \frac{1}{2} ( 1 + {e}^{- 2 {λ}_{k}} ) .$$

In one embodiment, in the generalized Pauli-Lindblad model, the Lindblad rate λₖ can be a complex number. As a result, the corresponding weight wₖ can also be a complex number. Therefore, the Pauli channel can be expressed as εₖ(ρ)=γₖ[qₖρ+e^{iφ}^{ₖ}(1−qₖ)PₖρPₖ), where

$${γ}_{k} = \frac{{w}_{k}}{\vert {w}_{k} \vert} ( \vert {w}_{k} \vert + \vert 1 - {w}_{k} \vert ) \\ {q}_{k} = \vert {w}_{k} \vert / ( \vert {w}_{k} \vert + \vert 1 - {w}_{k} \vert ) \\ {ϕ}_{k} = arg ( \frac{1 - {w}_{k}}{{w}_{k}} )$$

By defining parameter

$${ϕ}_{k} = arg ( \frac{1 - {w}_{k}}{{w}_{k}} ) ,$$

the derived quantity qₖ is real and positive. That is, φₖ defines the arguments of the complex number

$$( ( \frac{1 - {w}_{k}}{{w}_{k}} ) .$$

The argument of the complex number is the angle it makes with the positive real axis in the complex plane. By utilizing such a definition, the weight is related to a phase or rotation in the complex plane. By defining φₖ in such a manner, the quantity qₖ derived from φₖ is real and positive. Hence, even though the Lindblad rates and weights include complex numbers, a real and positive quantity may be derived.

In one embodiment, to implement εₖ, learning engine 201 implements either I or Pₖ with probability qₖ and 1−qₖ, respectively.

In one embodiment, in post-processing, the phase e^{iφ}^{ₖ} is added to the samples where Pₖ is applied. The results are then rescaled by γₖ.

In one embodiment, in order to implement ε(ρ)=Πₖεₖ(ρ), the above procedure is performed for each k. Furthermore, the results are processed with Πₖsₖγₖ where sₖ is the corresponding phase. The overhead factor for the protocol is then determined by γ=Πₖ|γₖ|.

It is noted that in cases where

$$Im ( {λ}_{k} ) = m \frac{π}{2}$$

with m∈Z, it is possible to factor the map as a composition of a unitary channel and a real Pauli-Lindblad map, which makes the implementation simpler. That is, when a complex number's imaginary part (λₖ) is a multiple of π/2 (where m is an integer), a certain type of quantum map can be simplified. In one embodiment, Im(λₖ) can be broken down into two simpler parts: a unitary channel and a real Pauli-Lindblad map making implementation easier.

Im(λₖ) refers to the imaginary part of a complex number denoted by λₖ. The term

$$m \frac{π}{2}$$

specifies a condition where the imagining part (Im(λₖ)) is equal to a multiple (m) of

$$\frac{π}{2} .$$

The term m ∈Z indicates that “m” is an integer.

In one embodiment, when

$$Im ( {λ}_{k} ) = m \frac{π}{2} ,$$

a certain type of quantum map, known as the “quantum channel” or “transformation” on a quantum state, can be separated into two types of operations: unitary channel and the Pauli-Lindblad map. The unitary channel operation does not dissipate energy and preserves the norm of the quantum state. It is a reversible transformation. The Pauli-Lindblad map operation is not unitary. By decomposing the map into these two simpler types of maps, the difficulty and complexity of its implementation is reduced leading to a clearer and more efficient way to perform the desired quantum operation.

Upon learning the generalized Pauli-Lindblad model, the generalized Pauli-Lindblad model can be utilized for simulating Pauli channels and performing quantum error mitigation (e.g., probabilistic error amplification, probabilistic error cancellation) as discussed below.

Classical computer 102 further includes measurement engine 202 configured to construct a quantum circuit and measure the Pauli fidelities of the constructed quantum circuit.

In one embodiment, measurement engine 202 constructs a quantum circuit (e.g., quantum circuit 109) by defining qubits, and applying quantum gates (and operations) in sequence to manipulate them.

In one embodiment, in connection with constructing the quantum circuit, measurement engine 202 initializes the qubits. In one embodiment, measurement engine 202 defines the number of qubits the quantum circuit requires. In one embodiment, the qubits are initialized to a state, such as the |0 [symbol] state.

In embodiment, measurement engine 202 applies the quantum gates (e.g., Hadamard, CNOT, etc.) sequentially, representing transformations on the qubits. Each quantum gate performs a specific quantum operation, such as creating superposition or entanglement.

Measurement engine 202 utilizes various software tools for constructing a quantum circuit, including, but not limited to, Qiskit®, Cirq®, Azure® Quantum, etc.

In one embodiment, measurement engine 202 measures the Pauli fidelities of the constructed quantum circuit. Pauli fidelities, as used herein, refer to a set of parameters used to characterize the performance of a quantum system or device. A Pauli fidelity, as used herein, quantifies how well a noise quantum channel (e.g., gate, process) preserves the expectation value of a particular Pauli operator.

In one embodiment, measurement engine 202 measures the Pauli fidelities of the constructed quantum circuit by using a combination of Pauli measurement and fidelity estimation techniques, such as measuring a random subset of Pauli observables and using the measurement statistics to estimate the fidelity (measures the similarity between two quantum states or the quality of a quantum operation).

In one embodiment, measurement engine 202 performs Pauli measurements, such as measuring a qubit in the Pauli basis (e.g., X, Y, Z) by applying appropriate gates (e.g., Hadamard gate for X measurement) before the standard measurement. Other measurements performed by measurement engine 202 include randomized benchmarking (technique involves running multiple circuits with random Pauli gates and measuring the resulting fidelities) and mid-circuit measurements (measuring qubits in the middle of a circuit execution, which can be useful for characterizing the state of qubits during the computation).

In one embodiment, after performing such measurements, the measurement statistics are used to estimate the fidelity of the quantum circuit. Furthermore, in one embodiment, measurement engine 202 analyzes the measurement results to estimate the rates of different Pauli errors (e.g., X, Y, Z errors).

Measurement engine 202 utilizes various software tools for measuring Pauli fidelities of the quantum circuit including, but not limited to, Qiskit®, Cirq®, PennyLane®, and Q-CTRL®.

Classical computer 102 additionally includes model fitting engine 203 configured to fit the measured fidelities to the generalized Pauli-Lindblad model with negative or complex rates (i.e., having parameters with negative or complex numbers). That is, the rates describing how the quantum system evolves due to noise are allowed to be negative or complex numbers rather than only real and positive numbers as in currently used Pauli-Lindblad models.

In one embodiment, model fitting engine 203 finds the best-fitting parameters for the generalized Pauli-Lindblad model that best match the measured fidelities (Pauli fidelities). In one embodiment, such measured fidelities quantify the quality of the quantum operation or process, where the higher the fidelity, the better the quality of the quantum operation or process. By utilizing the generalized Pauli-Lindblad model with negative or complex rates, such a model captures more complex and potentially non-intuitive noise behaviors.

In one embodiment, model fitting engine 203 utilizes a metric to quantify the difference between the generalized Pauli-Lindblad model's prediction and the measured fidelities (Pauli fidelities). For example, one such metric is the Hellinger distance, which measures the distance between probability distributions. Another example of such a metric is the total variation distance, which measures the distance between two probability distributions.

In one embodiment, model fitting engine 203 uses an optimization algorithm (e.g., gradient descent) to adjust the model parameters to minimize the loss function. Such model parameters are continuously adjusted until the generalized Pauli-Lindblad model's prediction accurately predicts the observed behavior. Such a process corresponds to fitting the measured fidelities to the generalized Pauli-Lindblad model.

Model fitting engine 203 utilizes various software tools for fitting the measured fidelities (Pauli fidelities) of the quantum circuit including, but not limited to, Qiskit®, Cirq®, Azure® Quantum, and TensorFlow®.

Classical computer 102 additionally includes mitigation engine 204 configured to generate a set of mitigation circuits by sampling from an inverse of the generalized Pauli-Lindblad model. The inverse of the noise model, such as the generalized Pauli-Lindblad model, is a model that, when applied, effectively cancels out the effects of the original noise. That is, the inverse of the noise model represents the process that would ideally “undo” the errors introduced by the original noise channel (the one that the generalized Pauli-Lindblad model is modeling). Sampling in this context, as used herein, refers to the process of randomly selecting elements from the inverse Pauli-Lindblad model. A mitigation circuit, as used herein, refers to a quantum circuit designed to apply the inverse noise model to the original circuit (constructed quantum circuit) effectively undoing the errors introduced by the noise. In this manner, the opposite of the noisy quantum process is simulated effectively undoing the errors introduced by the process by drawing random samples from a distribution that represents the inverse of the noise channel.

In one embodiment, mitigation engine 204 generates or constructs the set of mitigation circuits by constructing the inverse noise channels. In one embodiment, for each noise channel in the original circuit (constructed quantum circuit), a Pauli operator is sampled from the distribution associated with that channel's inverse. In one embodiment, mitigation engine 204 replaces the original noise channels in the circuit (constructed quantum circuit) with the sampled Pauli operators forming the set of mitigation circuits.

Mitigation engine 204 utilizes various software tools for generating the set of mitigation circuits by sampling from an inverse of the generalized Pauli-Lindblad model including, but not limited to, Qiskit®, Mitiq, etc.

In one embodiment, mitigation engine 204 performs quantum error mitigation on the quantum circuit (constructed quantum circuit) using the set of mitigation circuits. Examples of such quantum error mitigation techniques include probabilistic error amplification, and probabilistic error cancellation.

Probabilistic error amplification, as used herein, is a technique which introduces controlled noise to a quantum circuit to amplify existing errors. The amplified noise data is then used in conjunction with zero noise extrapolation, where the results from different noise levels are extrapolated to estimate what the results would be in a completely noise-free scenario.

Probabilistic error cancellation, as used herein, is a quantum error mitigation technique that aims to obtain accurate, bias-free estimates of physical observables by effectively inverting well-characterized noise channels through probabilistic insertion of recovery gates.

In one embodiment, mitigation engine 204 executes the constructed quantum circuit and the set of mitigation circuits on the quantum hardware of quantum computer 101. The results from the mitigation circuits are used to model or characterize the noise. The model is then used to correct the results from the constructed quantum circuit. The final output is the error-mitigated result, which is closer to the ideal result that would be obtained from a noiseless quantum computer.

Mitigation engine 204 utilizes various software tools for performing quantum error mitigation as discussed above, including, but not limited to, Mitiq, Qiskit®, Cirq®, PyQuil®, etc.

An example of applying the generalized Pauli-Lindblad model to probabilistic error amplification is discussed below.

The main building block of probabilistic error amplification is implementing a desired Pauli noise channel. First, the noise channel is learned and captured using the factorized Pauli-Lindblad model. Then, all λₖ are scaled to αλₖ and the additional noise is injected by the sampling scheme outlined above with the new αλₖ rates. In one embodiment, assuming a low-noise regime and λₖ∈ [symbol] , the overhead simplifies to γ_{αPEA}=exp(−2αΣ_{λ}_{ₖ}_{<0} Re(λₖ)). In an additional embodiment, bias and variance can be traded according to a criteria depending on the number of measurements and γ_{αPEA} and only amplify the λₖ>0.

An example of applying the generalized Pauli-Lindblad model to probabilistic error cancellation is discussed below.

In one embodiment, probabilistic error cancellation with the generalized Lindblad-Pauli noise model is devised to work with positive λₖ. In such cases, − [symbol] has negative rates. The general case without any restriction on λₖ can be implemented using the prescribed method. In one embodiment, assuming a low-noise regime and λₖ ∈ [symbol] the overhead simplifies to γ_{PEc}=exp(2αΣ_{λ}_{ₖ}_{>0} Re(λₖ)).

Furthermore, upon learning the generalized Pauli-Lindblad model, the generalized Pauli-Lindblad model can be utilized for simulating Pauli channels as discussed below.

Classical computer 102 further includes simulation engine 205 configured to sample parameters of the generalized Pauli-Lindblad model in a sequential manner to implement the Pauli channel as a full Pauli channel. A full Pauli channel, as used herein, refers to the complete and fully defined Pauli channel that encompasses all possible single-qubit Pauli errors.

As discussed above, by processing the parameters of the generalized Pauli-Lindblad model in a sequential manner rather than in a single, all-at-once operation, the sampling process mirrors sampling from the complete, fully defined Pauli-Lindblad model.

In one embodiment, simulation engine 205 performs sequential implementation by implementing the terms of the generalized Pauli-Lindblad model in sequence (one after another) as opposed to implementing all the terms at once.

In one embodiment, simulation engine 205 samples the parameters of the generalized Pauli-Lindblad model in a sequential manner by choosing the parameters one after another based on previous choices.

In one embodiment, simulation engine 205 simulates the full Pauli channel based on sampling the generalized Pauli-Lindblad model.

As stated above, in one embodiment, when implementing the terms of the generalized Pauli-Lindblad model sequentially, each term will result in a quantum state evolution. Such repeated implementation, or sampling, of the terms of the generalized Pauli-Lindblad model effectively simulates the full model's dynamics to understand the complex noise model.

In one embodiment, a Pauli channel can be simulated by sequentially implementing terms of the generalized Pauli-Lindblad model and sampling from them. By sequentially implementing the term results, such as implementing each error type or term one after another, the overall effect of the Pauli channel can be simulated.

In one embodiment, instead of directly calculating the outcome of each error, a sampling approach may be utilized, drawing random samples from the generalized Pauli-Lindblad model for each term to represent the errors probabilistically.

In one embodiment, by sequentially implementing these sampled terms, the entire Pauli channel can be simulated allowing for a more accurate understanding of the overall error behavior in the quantum system. That is, by sequentially applying the terms (representing source of noise or errors) via sampling, the combined effect of the entire model, including the full Pauli channel, can effectively be simulated. That is, all possible noise channel effects, such as Pauli rotations, can be implemented via such sampling.

An example of applying the generalized Pauli-Lindblad model to simulating Pauli channels is discussed below.

In one embodiment, using the procedure outlined above, a Monte Carlo simulation is performed with a factorized noise model. In one embodiment, assuming a low-noise regime and λₖ ∈ [symbol] , the overhead simplifies to γₛᵢₘ=exp(−Σ_{λ}_{ₖ}_{<0}2 Re(λₖ)).

Such simulations of the Pauli channel are utilized in connection with quantum error mitigation techniques, such as Pauli twirling and Pauli check sandwiching, which aim to transform arbitrary noise channels into Pauli channels, which are easier to model and mitigate.

In this manner, quantum error mitigation is improved by reducing errors by utilizing a generalized Pauli-Lindblad model that captures all the Pauli channels as opposed to a subclass of the Pauli channels.

A further description of these and other functions is provided below in connection with the discussion of the method for utilizing a generalized Pauli-Lindblad model for improving quantum error mitigation.

Prior to the discussion of the method for utilizing a generalized Pauli-Lindblad model for improving quantum error mitigation, a description of the hardware configuration of classical computer 102 (FIG. 1) is provided below in connection with FIG. 3.

Referring now to FIG. 3, in conjunction with FIG. 1, FIG. 3 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code 301 involved in performing the inventive methods, such as utilizing a generalized Pauli-Lindblad model for improving quantum error mitigation. In addition to block 301, computing environment 300 includes, for example, classical computer 102, network 113, such as a wide area network (WAN), end user device (EDU) 302, remote server 303, public cloud 304, and private cloud 305. In this embodiment, classical computer 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically classical computer 102, to keep the presentation as simple as possible. Classical computer 102 may be located in a cloud, even though it is not shown in a cloud in FIG. 3. On the other hand, classical computer 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto classical computer 102 to cause a series of operational steps to be performed by processor set 306 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 310 is located in a single package and is internal to classical computer 102, but, alternatively or additionally, the volatile memory may be distributed over multiple packages and/or located externally with respect to classical computer 102.

Persistent Storage 311 is any form of non-volatile storage for computers that is now known or to be developed in the future. The non-volatility of this storage means that the stored data is maintained regardless of whether power is being supplied to classical computer 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows classical computer 102 to communicate with other computers through WAN 113. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to classical computer 102 from an external computer or external storage device through a network adapter card or network interface included in network module 317.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates classical computer 102), and may take any of the forms discussed above in connection with classical computer 102. EUD 302 typically receives helpful and useful data from the operations of classical computer 102. For example, in a hypothetical case where classical computer 102 is designed to provide a recommendation to an end user, this recommendation would typically be communicated from network module 817 of classical computer 102 through WAN 113 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to classical computer 102. Remote server 303 may be controlled and used by the same entity that operates classical computer 102. Remote server 303 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to utilize a generalized Pauli-Lindblad model for improving quantum error mitigation. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for utilizing a generalized Pauli-Lindblad model for improving quantum error mitigation, may be embodied in an application-specific integrated circuit.

As stated above, current quantum hardware, however, is subject to different sources of noise, the most well-known being qubit decoherence, individual gate errors, and measurement errors, These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation techniques have been developed. Quantum error mitigation refers to mitigating computation errors while keeping the hardware load to a minimum. That is, quantum error mitigation is a technique that reduces the effects of noise and error on measured observables. Quantum error mitigation techniques, such as probabilistic error cancellation and probabilistic error amplification, benefit from accurate noise models. The Pauli-Lindblad noise model is one of the most successful models for those applications. In existing implementations, the model decomposes into a series of simple Pauli channels with one- and two-local terms that follow the qubit topology. Currently, noise learning protocols for quantum error mitigation procedures use a learning and migration scheme that only works if the noise has positive generators (evolution of a quantum system's state). As a result, the constraints for the parameters of the Pauli-Lindblad model are limited to only positive values resulting in the capture of only a subclass of Pauli channels. A Pauli channel is a quantum channel that probabilistically applies a Pauli operator (set of operators, denoted as X, Y, and Z, that correspond to the spin along the x, y, and z axes, respectively) to the input state. Unfortunately, by only capturing a subclass of Pauli channels, systematic errors result during quantum error mitigation.

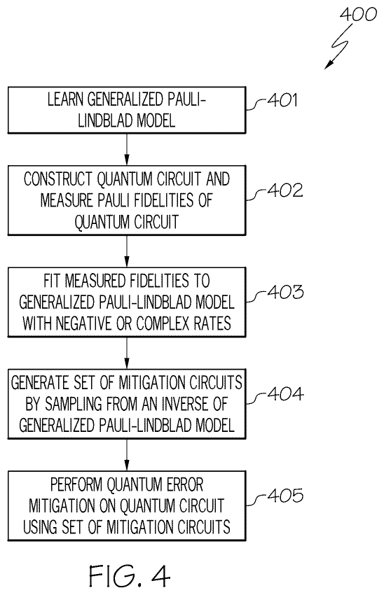

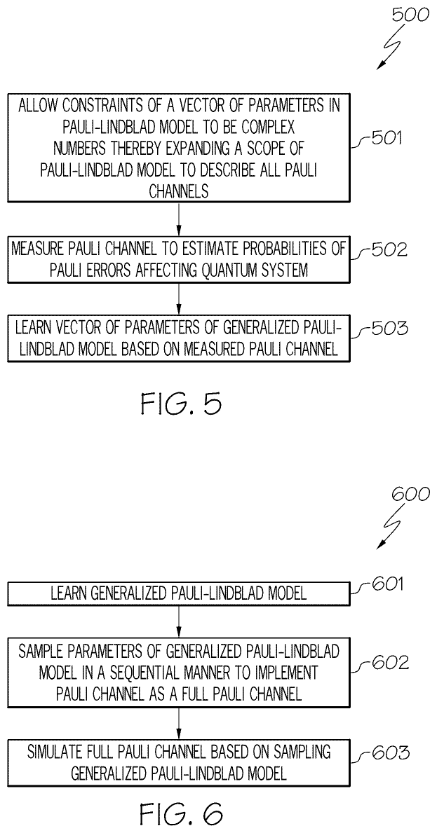

The embodiments of the present disclosure provide the means for reducing errors during quantum mitigation by utilizing a generalized Pauli-Lindblad model that captures all the Pauli channels as opposed to a subclass of the Pauli channels as discussed below in connection with FIGS. 4-6. FIG. 4 is a flowchart of a method for utilizing a generalized Pauli-Lindblad model for improving quantum error mitigation. FIG. 5 is a flowchart of a method for learning the generalized Pauli-Lindblad model. FIG. 6 is a flowchart of a method for simulating a full Pauli channel using the generalized Pauli-Lindblad model.

As stated above, FIG. 4 is a flowchart of a method 400 for utilizing a generalized Pauli-Lindblad model for improving quantum error mitigation in accordance with an embodiment of the present disclosure.

Referring to FIG. 4, in conjunction with FIGS. 1-3, in step 401, learning engine 201 learns a generalized Pauli-Lindblad model.

As stated above, a Pauli-Lindblad model (also referred to as the “Pauli-Lindblad noise model”), as used herein, refers to a model that decomposes into a series of Pauli channels with one- and two-local terms that follow the qubit topology. A generalized Pauli-Lindblad model, as used herein, refers to a Pauli-Lindblad model where the constraints of the parameters of the Pauli-Lindblad model have been relaxed to include complex numbers. The parameters, such as a vector of parameters, of the generalized Pauli-Lindblad model are learned based on measuring a Pauli channel to estimate the probabilities of the Pauli errors affecting the quantum system.

A discussion regarding learning the generalized Pauli-Lindblad model is provided below in connection with FIG. 5.

FIG. 5 is a flowchart of a method 500 for learning the generalized Pauli-Lindblad model in accordance with an embodiment of the present disclosure.

Referring to FIG. 5, in conjunction with FIGS. 1-4, in step 501, learning engine 201 allows the constraints of the parameters, such as a vector of parameters (\vec{λ}), of the Pauli-Lindblad model to be relaxed so that the parameters include complex numbers thereby expanding a scope of the Pauli-Lindblad model to describe all Pauli channels.

In step 502, learning engine 201 measures a Pauli channel to estimate the probabilities of the Pauli errors affecting the quantum system (e.g., quantum computer 101).

As discussed above, a Pauli channel, as used herein, refers to a quantum channel that probabilistically applies a Pauli operator to the input state. It is a fundamental model for noise in quantum systems and is used to analyze error correction and fault tolerance. A Pauli operator, as used herein, refers to a set of operators, denoted as X, Y, and Z, that correspond to the spin along the x, y, and z axes, respectively.

In step 503, learning engine 201 learns the vector of parameters (\vec{λ}) of the generalized Pauli-Lindblad model based on the measured Pauli channel as discussed further below.

As stated above, in one embodiment, the measured Pauli channel is represented by ε(ρ)=ΣₖpₖPₖρPₖ. In one embodiment, the generator (generates the evolution of the quantum state) is [symbol] (ρ)=Σₖλₖ(PₖρPₖ−ρ) such that [symbol] =ε.

In the context of quantum computing and the Lindblad master equation, the generator ( [symbol] (ρ)) is the evolution of a quantum system's state (represented by the density matrix ρ) which is by an operator, L(ρ), which describes the system's dynamics. The Lindblad master equation describes the time evolution of an open quantum system (a system that interacts with its environment). The density matrix (ρ), as used herein, represents the statistical properties of a quantum system, including its coherence and purity. The operator, L(ρ), when applied to the density matrix, determines how the quantum system evolves over time due to interactions with its environment. The Lindbladian generator or L generates evolution through ρ(t)≈ρ(0)+dtLρ(0). In this sense, the generator describes how the system changes its state over time as a result of interactions with the environment.

Furthermore, in one embodiment, learning engine 201 finds the vector of parameters (\vec{λ}) using the following formula:

$$\vec{λ} = \frac{1}{{d}^{2}} H log ( H \vec{p} ) ,$$

where H is the Walsh-Hadamard transform (hᵢⱼ=1 if [Pᵢ, Pⱼ]=0 and −1 otherwise), d is the dimension, and \vec{p} is the vector of error probabilities.

In one embodiment, for models with locality constraints,

$$\vec{λ} = min ( {‖ A \vec{λ} - \vec{y} ‖}_{2}^{2} ) ,$$

where \vec{y} is the vector of the logarithm of measured local fidelities, and A is a matrix showing how \vec{λ} linearly depends on \vec{y}. A solution is given by \vec{λ}=A⁻¹ \vec{y}.

Hence, the vector \vec{λ} is based on the logarithm of measured local fidelities under the constraint of locality. That is, the model's behavior needs to be consistent with the local properties it is trying to model. In one embodiment, the vector \vec{λ} is computed by finding the minimal difference between a transformed model λ, (A\vec{λ}), and measured local log-fidelities (\vec{y}), where A is a matrix representing this relationship.

In one embodiment, the equation

$$( \vec{λ} = min ( {‖ A \vec{λ} - \vec{y} ‖}_{2}^{2} )$$

is a minimization problem. The goal is to find the best λ that minimizes the difference between a transformed model λ (represented by (A\vec{λ})) and the vector of logarithms of measured local log-fidelities (\vec{y}). In one embodiment, \vec{y} represents the vector of logarithms of measured local fidelities, where “local fidelities” refer to a measure of how accurately a model predicts in a specific locality. A represents a matrix that defines how \vec{λ} changes with \vec{y}. That is, A is a map that represents how the “unconstrained model parameters” \vec{λ} transform to incorporate the locality constraints from the measured local fidelities, \vec{y}.

Furthermore, as previously discussed, the solution is given by \vec{λ}=A⁻¹\vec{y}, which indicates that if the matrix A is invertible, then a solution for \vec{λ} can be obtained by applying the inverse of A to the vector \vec{y}.

In one embodiment, learning engine 201 does not impose the requirement that the values of the vector of parameters (\vec{λ}) are positive. Such values may be negative or complex numbers. As a result, the Pauli-Lindblad model is generalized (i.e., the generalized Pauli-Lindblad model) such that it is able to capture all Pauli channels.

In one embodiment, all the terms in the generalized Pauli-Lindblad model commute. That is, ε(ρ)=Πₖεₖ(ρ)=Πₖ [symbol] (ρ) where [symbol] ₖ(ρ)=λₖ(PₖρPₖ−ρ). In other words, changing the order of the terms used in the operation does not change the final result.

As a result, each term (parameter) in the generalized Pauli-Lindblad model, which represents a particular type or strength of noise, may be implemented individually. In one embodiment, learning engine 201 performs sequential implementation of the terms in the generalized Pauli-Lindblad model, which results in sampling from the full model. That is, by processing the parameters of the generalized Pauli-Lindblad model in a sequential manner rather than in a single, all-at-once operation, the sampling process mirrors sampling from the complete, fully defined Pauli-Lindblad model.

In one embodiment, learning engine 201 performs sequential implementation by implementing the terms of the generalized Pauli-Lindblad model in sequence (one after another) as opposed to implementing all the terms at once.

In one embodiment, when implementing the terms of the generalized Pauli-Lindblad model sequentially, each term will result in a quantum state evolution. Such repeated implementation, or sampling, of the terms of the generalized Pauli-Lindblad model effectively simulates the full model's dynamics to understand the complex noise model.

In one embodiment, a Pauli channel can be simulated by sequentially implementing terms of the generalized Pauli-Lindblad model and sampling from them. By sequentially implementing the term results, such as implementing each error type or term one after another, the overall effect of the Pauli channel can be simulated.

In one embodiment, instead of directly calculating the outcome of each error, a sampling approach may be utilized, drawing random samples from the generalized Pauli-Lindblad model for each term to represent the errors probabilistically.

In one embodiment, by sequentially implementing these sampled terms, the entire Pauli channel can be simulated allowing for a more accurate understanding of the overall error behavior in the quantum system. That is, by sequentially applying the terms (representing source of noise or errors) via sampling, the combined effect of the entire model, including the full Pauli channel, can effectively be simulated. That is, all possible noise channel effects, such as Pauli rotations, can be implemented via such sampling.

In one embodiment, [symbol] ₖ(ρ)=λₖ(PₖρPₖ−ρ). As a result, the generated channel is εₖ(ρ)=wₖρ+(1−wₖ)PₖρPₖ, where

$${w}_{k} = \frac{1}{2} ( 1 + {e}^{- 2 {λ}_{k}} ) .$$

In one embodiment, in the generalized Pauli-Lindblad model, the Lindblad rate λₖ can be a complex number. As a result, the corresponding weight wₖ can also be a complex number. Therefore, the Pauli channel can be expressed as εₖ(ρ)=γₖ[qₖρ+e^{iφ}^{ₖ}(1−qₖ)PₖρPₖ), where

$${γ}_{k} = \frac{{w}_{k}}{\vert {w}_{k} \vert} ( \vert {w}_{k} \vert + \vert 1 - {w}_{k} \vert )$$

$${q}_{k} = \vert {w}_{k} \vert / ( \vert {w}_{k} \vert + \vert 1 - {w}_{k} \vert )$$

$${ϕ}_{k} = arg ( \frac{1 - {w}_{k}}{{w}_{k}} )$$

By defining parameter

$${ϕ}_{k} = arg ( \frac{1 - {w}_{k}}{{w}_{k}} ) ,$$

the derived quantity qₖ is real and positive. That is, φₖ defines the arguments of the complex number

$$( ( \frac{1 - {w}_{k}}{{w}_{k}} ) .$$

The argument of the complex number is the angle it makes with the positive real axis in the complex plane. By utilizing such a definition, the weight is related to a phase or rotation in the complex plane. By defining φₖ in such a manner, the quantity qₖ derived from φₖ is real and positive. Hence, even though the Lindblad rates and weights include complex numbers, a real and positive quantity may be derived.

In one embodiment, to implement εₖ, learning engine 201 implements either I or Pₖ with probability qₖ and 1−qₖ, respectively.

In one embodiment, in post-processing, the phase e^{iφ}^{ₖ} is added to the samples where Pₖ is applied. The results are then resealed by γₖ.

In one embodiment, in order to implement ε(ρ)=Πₖεₖ(ρ), the above procedure is performed for each k. Furthermore, the results are processed with Πₖsₖγₖ where sₖ is the corresponding phase. The overhead factor for the protocol is then determined by γ=Πₖ|yₖ|.

It is noted that in cases where

$$Im ( {λ}_{k} ) = m \frac{π}{2}$$

with m∈Z, it is possible to factor the map as a composition of a unitary channel and a real Pauli-Lindblad map, which makes the implementation simpler. That is, when a complex number's imaginary part (λₖ) is a multiple of π/2 (where m is an integer), a certain type of quantum map can be simplified. In one embodiment, Im(λₖ) can be broken down into two simpler parts: a unitary channel and a real Pauli-Lindblad map making implementation easier.

Im(λₖ) refers to the imaginary part of a complex number denoted by λₖ. The term

$$m \frac{π}{2}$$

specifies a condition where the imagining part (Im(λₖ)) is equal to a multiple (m) of

$$\frac{π}{2} .$$

The term m∈Z indicates that “m” is an integer.

In one embodiment, when

$$Im ( {λ}_{k} ) = m \frac{π}{2} ,$$

a certain type of quantum map, known as the “quantum channel” or “transformation” on a quantum state, can be separated into two types of operations: unitary channel and the Pauli-Lindblad map. The unitary channel operation does not dissipate energy and preserves the norm of the quantum state. It is a reversible transformation. The Pauli-Lindblad map operation is not unitary. By decomposing the map into these two simpler types of maps, the difficulty and complexity of its implementation is reduced leading to a clearer and more efficient way to perform the desired quantum operation.

Upon learning the generalized Pauli-Lindblad model, the generalized Pauli-Lindblad model can be utilized for simulating Pauli channels and performing quantum error mitigation (e.g., probabilistic error amplification, probabilistic error cancellation) as discussed below.

Returning to FIG. 4, in conjunction with FIGS. 1-3 and 5, in step 402, measurement engine 202 constructs a quantum circuit and measures the Pauli fidelities of the constructed quantum circuit.

As discussed above, in one embodiment, measurement engine 202 constructs a quantum circuit (e.g., quantum circuit 109) by defining qubits, and applying quantum gates (and operations) in sequence to manipulate them.

In one embodiment, in connection with constructing the quantum circuit, measurement engine 202 initializes the qubits. In one embodiment, measurement engine 202 defines the number of qubits the quantum circuit requires. In one embodiment, the qubits are initialized to a state, such as the |0 [symbol] state.

In embodiment, measurement engine 202 applies the quantum gates (e.g., Hadamard, CNOT, etc.) sequentially, representing transformations on the qubits. Each quantum gate performs a specific quantum operation, such as creating superposition or entanglement.

Measurement engine 202 utilizes various software tools for constructing a quantum circuit, including, but not limited to, Qiskit®, Cirq®, Azure® Quantum, etc.

In one embodiment, measurement engine 202 measures the Pauli fidelities of the constructed quantum circuit. Pauli fidelities, as used herein, refer to a set of parameters used to characterize the performance of a quantum system or device. A Pauli fidelity, as used herein, quantifies how well a noise quantum channel (e.g., gate, process) preserves the expectation value of a particular Pauli operator.

In one embodiment, measurement engine 202 measures the Pauli fidelities of the constructed quantum circuit by using a combination of Pauli measurement and fidelity estimation techniques, such as measuring a random subset of Pauli observables and using the measurement statistics to estimate the fidelity (measures the similarity between two quantum states or the quality of a quantum operation).

In one embodiment, measurement engine 202 performs Pauli measurements, such as measuring a qubit in the Pauli basis (e.g., X, Y, Z) by applying appropriate gates (e.g., Hadamard gate for X measurement) before the standard measurement. Other measurements performed by measurement engine 202 include randomized benchmarking (technique involves running multiple circuits with random Pauli gates and measuring the resulting fidelities) and mid-circuit measurements (measuring qubits in the middle of a circuit execution, which can be useful for characterizing the state of qubits during the computation).

In one embodiment, after performing such measurements, the measurement statistics are used to estimate the fidelity of the quantum circuit. Furthermore, in one embodiment, measurement engine 202 analyzes the measurement results to estimate the rates of different Pauli errors (e.g., X, Y, Z errors).

Measurement engine 202 utilizes various software tools for measuring Pauli fidelities of the quantum circuit including, but not limited to, Qiskit®, Cirq®, PennyLane®, and Q-CTRL®.

In step 403, model fitting engine 203 fits the measured fidelities to the generalized Pauli-Lindblad model with negative or complex rates (i.e., having parameters with negative or complex numbers). That is, the rates describing how the quantum system evolves due to noise are allowed to be negative or complex numbers rather than only real and positive numbers as in currently used Pauli-Lindblad models.

As stated above, in one embodiment, model fitting engine 203 finds the best-fitting parameters for the generalized Pauli-Lindblad model that best match the measured fidelities (Pauli fidelities). In one embodiment, such measured fidelities quantify the quality of the quantum operation or process, where the higher the fidelity, the better the quality of the quantum operation or process. By utilizing the generalized Pauli-Lindblad model with negative or complex rates, such a model captures more complex and potentially non-intuitive noise behaviors.

In one embodiment, model fitting engine 203 utilizes a metric to quantify the difference between the generalized Pauli-Lindblad model's prediction and the measured fidelities (Pauli fidelities). For example, one such metric is the Hellinger distance, which measures the distance between probability distributions. Another example of such a metric is the total variation distance, which measures the distance between two probability distributions.

In one embodiment, model fitting engine 203 uses an optimization algorithm (e.g., gradient descent) to adjust the model parameters to minimize the loss function. Such model parameters are continuously adjusted until the generalized Pauli-Lindblad model's prediction accurately predicts the observed behavior. Such a process corresponds to fitting the measured fidelities to the generalized Pauli-Lindblad model.

Model fitting engine 203 utilizes various software tools for fitting the measured fidelities (Pauli fidelities) of the quantum circuit including, but not limited to, Qiskit®, Cirq®, Azure® Quantum, and TensorFlow®.

In step 404, mitigation engine 204 generates a set of mitigation circuits by sampling from an inverse of the generalized Pauli-Lindblad model.

As discussed above, the inverse of the noise model, such as the generalized Pauli-Lindblad model, is a model that, when applied, effectively cancels out the effects of the original noise. That is, the inverse of the noise model represents the process that would ideally “undo” the errors introduced by the original noise channel (the one that the generalized Pauli-Lindblad model is modeling). Sampling in this context, as used herein, refers to the process of randomly selecting elements from the inverse Pauli-Lindblad model. A mitigation circuit, as used herein, refers to a quantum circuit designed to apply the inverse noise model to the original circuit (constructed quantum circuit) effectively undoing the errors introduced by the noise. In this manner, the opposite of the noisy quantum process is simulated effectively undoing the errors introduced by the process by drawing random samples from a distribution that represents the inverse of the noise channel.

In one embodiment, mitigation engine 204 generates or constructs the set of mitigation circuits by constructing the inverse noise channels. In one embodiment, for each noise channel in the original circuit (constructed quantum circuit), a Pauli operator is sampled from the distribution associated with that channel's inverse. In one embodiment, mitigation engine 204 replaces the original noise channels in the circuit (constructed quantum circuit) with the sampled Pauli operators forming the set of mitigation circuits.

Mitigation engine 204 utilizes various software tools for generating the set of mitigation circuits by sampling from an inverse of the generalized Pauli-Lindblad model including, but not limited to, Qiskit®, Mitiq, etc.

In step 405, mitigation engine 204 performs quantum error mitigation on the quantum circuit (constructed quantum circuit) using the set of mitigation circuits.

As stated above, examples of such quantum error mitigation techniques include probabilistic error amplification, and probabilistic error cancellation.

Probabilistic error amplification, as used herein, is a technique which introduces controlled noise to a quantum circuit to amplify existing errors. The amplified noise data is then used in conjunction with zero noise extrapolation, where the results from different noise levels are extrapolated to estimate what the results would be in a completely noise-free scenario.

Probabilistic error cancellation, as used herein, is a quantum error mitigation technique that aims to obtain accurate, bias-free estimates of physical observables by effectively inverting well-characterized noise channels through probabilistic insertion of recovery gates.

In one embodiment, mitigation engine 204 executes the constructed quantum circuit and the set of mitigation circuits on the quantum hardware of quantum computer 101. The results from the mitigation circuits are used to model or characterize the noise. The model is then used to correct the results from the constructed quantum circuit. The final output is the error-mitigated result, which is closer to the ideal result that would be obtained from a noiseless quantum computer.

Mitigation engine 204 utilizes various software tools for performing quantum error mitigation as discussed above, including, but not limited to, Mitiq, Qiskit®, Cirq®, PyQuil®, etc.

An example of applying the generalized Pauli-Lindblad model to probabilistic error amplification is discussed below.

The main building block of probabilistic error amplification is implementing a desired Pauli noise channel. First, the noise channel is learned and captured using the factorized Pauli-Lindblad model. Then, all λₖ are scaled to αλₖ and the additional noise is injected by the sampling scheme outlined above with the new αλk rates. In one embodiment, assuming a low-noise regime and λₖ ∈ [symbol] , the overhead simplifies to γ_{αPEA}=exp(−2αΣ_{λ}_{ₖ}_{<0} Re(λₖ)). In an additional embodiment, bias and variance can be traded according to a criteria depending on the number of measurements and γ_{αPEA} and only amplify the λₖ>0.

An example of applying the generalized Pauli-Lindblad model to probabilistic error cancellation is discussed below.

In one embodiment, probabilistic error cancellation with the generalized Lindblad-Pauli noise model is devised to work with positive λₖ. In such cases, [symbol] has negative rates. The general case without any restriction on λₖ can be implemented using the prescribed method. In one embodiment, assuming a low-noise regime and λₖ ∈ [symbol] , the overhead simplifies to γ_{PEC}=exp(2αΣ_{λ}_{ₖ}_{>0} Re(λₖ)).

Furthermore, upon learning the generalized Pauli-Lindblad model, the generalized Pauli-Lindblad model can be utilized for simulating Pauli channels as discussed below in connection with FIG. 6.

FIG. 6 is a flowchart of a method 600 for simulating a full Pauli channel using the generalized Pauli-Lindblad model in accordance with an embodiment of the present disclosure.

Referring to FIG. 6, in conjunction with FIGS. 1-5, in step 601, learning engine 201 learns the generalized Pauli-Lindblad model as discussed above.

In step 602, simulation engine 205 samples parameters of the generalized Pauli-Lindblad model in a sequential manner to implement the Pauli channel as a full Pauli channel. A full Pauli channel, as used herein, refers to the complete and fully defined Pauli channel that encompasses all possible single-qubit Pauli errors.

As discussed above, by processing the parameters of the generalized Pauli-Lindblad model in a sequential manner rather than in a single, all-at-once operation, the sampling process mirrors sampling from the complete, fully defined Pauli-Lindblad model.

In one embodiment, simulation engine 205 performs sequential implementation by implementing the terms of the generalized Pauli-Lindblad model in sequence (one after another) as opposed to implementing all the terms at once.

In one embodiment, simulation engine 205 samples the parameters of the generalized Pauli-Lindblad model in a sequential manner by choosing the parameters one after another based on previous choices.

In step 603, simulation engine 205 simulates the full Pauli channel based on sampling the generalized Pauli-Lindblad model.

As stated above, in one embodiment, when implementing the terms of the generalized Pauli-Lindblad model sequentially, each term will result in a quantum state evolution. Such repeated implementation, or sampling, of the terms of the generalized Pauli-Lindblad model effectively simulates the full model's dynamics to understand the complex noise model.

In one embodiment, a Pauli channel can be simulated by sequentially implementing terms of the generalized Pauli-Lindblad model and sampling from them. By sequentially implementing the term results, such as implementing each error type or term one after another, the overall effect of the Pauli channel can be simulated.

In one embodiment, instead of directly calculating the outcome of each error, a sampling approach may be utilized, drawing random samples from the generalized Pauli-Lindblad model for each term to represent the errors probabilistically.

In one embodiment, by sequentially implementing these sampled terms, the entire Pauli channel can be simulated allowing for a more accurate understanding of the overall error behavior in the quantum system. That is, by sequentially applying the terms (representing source of noise or errors) via sampling, the combined effect of the entire model, including the full Pauli channel, can effectively be simulated. That is, all possible noise channel effects, such as Pauli rotations, can be implemented via such sampling.

An example of applying the generalized Pauli-Lindblad model to simulating Pauli channels is discussed below.

In one embodiment, using the procedure outlined above, a Monte Carlo simulation is performed with a factorized noise model. In one embodiment, assuming a low-noise regime and λₖ ∈ [symbol] , the overhead simplifies to γₛᵢₘ=exp(−Σ_{λ}_{ₖ}_{<0}2 Re(λₖ)).

Such simulations of the Pauli channel are utilized in connection with quantum error mitigation techniques, such as Pauli twirling and Pauli check sandwiching, which aim to transform arbitrary noise channels into Pauli channels, which are easier to model and mitigate.

In this manner, quantum error mitigation is improved by reducing errors by utilizing a generalized Pauli-Lindblad model that captures all the Pauli channels as opposed to a subclass of the Pauli channels.

Furthermore, the principles of the present disclosure improve the technology or technical field involving quantum error mitigation.

As discussed above, current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation techniques have been developed. Quantum error mitigation refers to mitigating computation errors while keeping the hardware load to a minimum. That is, quantum error mitigation is a technique that reduces the effects of noise and error on measured observables. Quantum error mitigation techniques, such as probabilistic error cancellation and probabilistic error amplification, benefit from accurate noise models. The Pauli-Lindblad noise model is one of the most successful models for those applications. In existing implementations, the model decomposes into a series of simple Pauli channels with one- and two-local terms that follow the qubit topology. Currently, noise learning protocols for quantum error mitigation procedures use a learning and migration scheme that only works if the noise has positive generators (evolution of a quantum system's state). As a result, the constraints for the parameters of the Pauli-Lindblad model are limited to only positive values resulting in the capture of only a subclass of Pauli channels. A Pauli channel is a quantum channel that probabilistically applies a Pauli operator (set of operators, denoted as X, Y, and Z, that correspond to the spin along the x, y, and z axes, respectively) to the input state. Unfortunately, by only capturing a subclass of Pauli channels, systematic errors result during quantum error mitigation.

Embodiments of the present disclosure improve such technology by constructing a quantum circuit and measuring Pauli fidelities of the quantum circuit. Pauli fidelities, as used herein, refer to a set of parameters used to characterize the performance of a quantum system or device. A Pauli fidelity, as used herein, quantifies how well a noise quantum channel (e.g., gate, process) preserves the expectation value of a particular Pauli operator. The measured fidelities are then fitted to the generalized Pauli-Lindblad model with negative or complex rates (i.e., having parameters with negative or complex numbers), which enables the generalized Pauli-Lindblad model to capture all the Pauli channels. That is, the rates describing how the quantum system evolves due to noise are allowed to be negative or complex numbers rather than only real and positive numbers as in currently used Pauli-Lindblad models. In one embodiment, in the generalized Pauli-Lindblad model, the Lindblad rate λₖ can be a complex number. As a result, the corresponding weight wₖ can also be a complex number. A set of mitigation circuits is then generated by sampling from an inverse of the generalized Pauli-Lindblad model. A mitigation circuit, as used herein, refers to a quantum circuit designed to reduce the effects of noise errors or noise during quantum computations. The mitigation circuits are then used to perform quantum error mitigation on the quantum circuit. In this manner, quantum error mitigation is improved by reducing errors by utilizing a generalized Pauli-Lindblad model that captures all the Pauli channels as opposed to a subclass of the Pauli channels. Furthermore, in this manner, there is an improvement in the technical field involving quantum error mitigation.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for quantum error mitigation, the method comprising:
constructing a quantum circuit and measuring Pauli fidelities of said quantum circuit;
fitting said Pauli fidelities to a generalized Pauli-Lindblad model with negative or complex rates;
generating mitigation circuits by sampling from an inverse of said generalized Pauli-Lindblad model; and
performing quantum error mitigation on said quantum circuit using said mitigation circuits.

2. The method as recited in claim 1 further comprising:
allowing a vector of parameters used in said generalized Pauli-Lindblad model to include complex numbers thereby expanding a scope of said generalized Pauli-Lindblad model to describe all Pauli channels.

3. The method as recited in claim 2 further comprising:
measuring a Pauli channel to estimate probabilities of Pauli errors affecting a quantum system; and
learning said vector of parameters of said generalized Pauli-Lindblad model based on said measured Pauli channel.

4. The method as recited in claim 3 further comprising:
sampling said parameters of said generalized Pauli-Lindblad model in a sequential manner to implement said Pauli channel as a full Pauli channel.

5. The method as recited in claim 1 further comprising:
simulating a full Pauli channel based on sampling said generalized Pauli-Lindblad model.

6. The method as recited in claim 1, wherein said quantum error mitigation comprises probabilistic error amplification.

7. The method as recited in claim 1, wherein said quantum error mitigation comprises probabilistic error cancellation.

8. A computer program product for quantum error mitigation, the computer program product comprising one or more computer readable storage mediums having program code embodied therewith, the program code comprising programming instructions for:
constructing a quantum circuit and measuring Pauli fidelities of said quantum circuit;
fitting said Pauli fidelities to a generalized Pauli-Lindblad model with negative or complex rates;
generating mitigation circuits by sampling from an inverse of said generalized Pauli-Lindblad model; and
performing quantum error mitigation on said quantum circuit using said mitigation circuits.

9. The computer program product as recited in claim 8, wherein the program code further comprises the programming instructions for:
allowing a vector of parameters used in said generalized Pauli-Lindblad model to include complex numbers thereby expanding a scope of said generalized Pauli-Lindblad model to describe all Pauli channels.

10. The computer program product as recited in claim 9, wherein the program code further comprises the programming instructions for:
measuring a Pauli channel to estimate probabilities of Pauli errors affecting a quantum system; and
learning said vector of parameters of said generalized Pauli-Lindblad model based on said measured Pauli channel.

11. The computer program product as recited in claim 10, wherein the program code further comprises the programming instructions for:
sampling said parameters of said generalized Pauli-Lindblad model in a sequential manner to implement said Pauli channel as a full Pauli channel.

12. The computer program product as recited in claim 8, wherein the program code further comprises the programming instructions for:
simulating a full Pauli channel based on sampling said generalized Pauli-Lindblad model.

13. The computer program product as recited in claim 8, wherein said quantum error mitigation comprises probabilistic error amplification.

14. The computer program product as recited in claim 8, wherein said quantum error mitigation comprises probabilistic error cancellation.

15. A system, comprising:
a memory for storing a computer program for quantum error mitigation; and
a processor connected to said memory, wherein said processor is configured to execute program instructions of the computer program comprising:
constructing a quantum circuit and measuring Pauli fidelities of said quantum circuit;
fitting said Pauli fidelities to a generalized Pauli-Lindblad model with negative or complex rates;
generating mitigation circuits by sampling from an inverse of said generalized Pauli-Lindblad model; and
performing quantum error mitigation on said quantum circuit using said mitigation circuits.

16. The system as recited in claim 15, wherein the program instructions of the computer program further comprise:
allowing a vector of parameters used in said generalized Pauli-Lindblad model to include complex numbers thereby expanding a scope of said generalized Pauli-Lindblad model to describe all Pauli channels.

17. The system as recited in claim 16, wherein the program instructions of the computer program further comprise:
measuring a Pauli channel to estimate probabilities of Pauli errors affecting a quantum system; and
learning said vector of parameters of said generalized Pauli-Lindblad model based on said measured Pauli channel.

18. The system as recited in claim 17, wherein the program instructions of the computer program further comprise:
sampling said parameters of said generalized Pauli-Lindblad model in a sequential manner to implement said Pauli channel as a full Pauli channel.

19. The system as recited in claim 15, wherein the program instructions of the computer program further comprise:
simulating a full Pauli channel based on sampling said generalized Pauli-Lindblad model.

20. The system as recited in claim 15, wherein said quantum error mitigation comprises one or more of the following selected from the group consisting of probabilistic error amplification and probabilistic error cancellation.
